(19) United States
(12) Patent Application Publication
(10) Pub. No.: US 2006/0293927 A1
(43) Pub. Date: Dec. 28, 2006

(54) Payd

(76) Inventor: Vijaykanth Reddy Tummalapally, Marietta, GA (US)

Correspondence Address: VIJAYKANTH REDDY TUMMALAPALLY, 1834 CHASEWOOD PARK DRIVE, MARIETTA, GA, 30066, US

(21) Appl. No.: 11/158,603

(22) Filed: Jun. 22, 2005

(51) Int. Cl. G06Q 10/00

(52) U.S. Cl. 705/4; 705/2

(57) ABSTRACT

The invented business method introduces a system and processes which accelerate payment processing to enable a service provider to be paid in the shortest time possible and much earlier than the normal settlement process by introduction of intermediaries, systems and processes not in current use for such purpose and in such mode or method. The first application of this system and method will be for the benefit of medical practitioners having independent practice or shared practice in physician clinics or other facilities. Using this system, physicians can get their due payments within 48 hours of submitting their bills, in an error-free straight-line processing experience. The method and system implementation includes an evaluation of the medical practice; conducting a sizing exercise to define two-month business volumes of the medical practice; and establishing billing, coding, and audit procedures. The key role in this method/system is played by the entity/entities who will implement, maintain and administer this system/method and therefore will have ownership and responsibility for the whole process. For ease of understanding the flow of transactions, these process owners will be named as “Claim Accelerators”. In a normal transaction cycle, the medical practitioner will send the claims data to the Claims Accelerator, who will use established procedures, systems and methods to verify/validate the sanctity of the claim and simultaneously take two actions: file the insurance claim and pay the doctor. In essence, the doctor does not have to manage billing and collections. He will get paid by the Claim Accelerator, and does not have to wait months for processing of his claims.

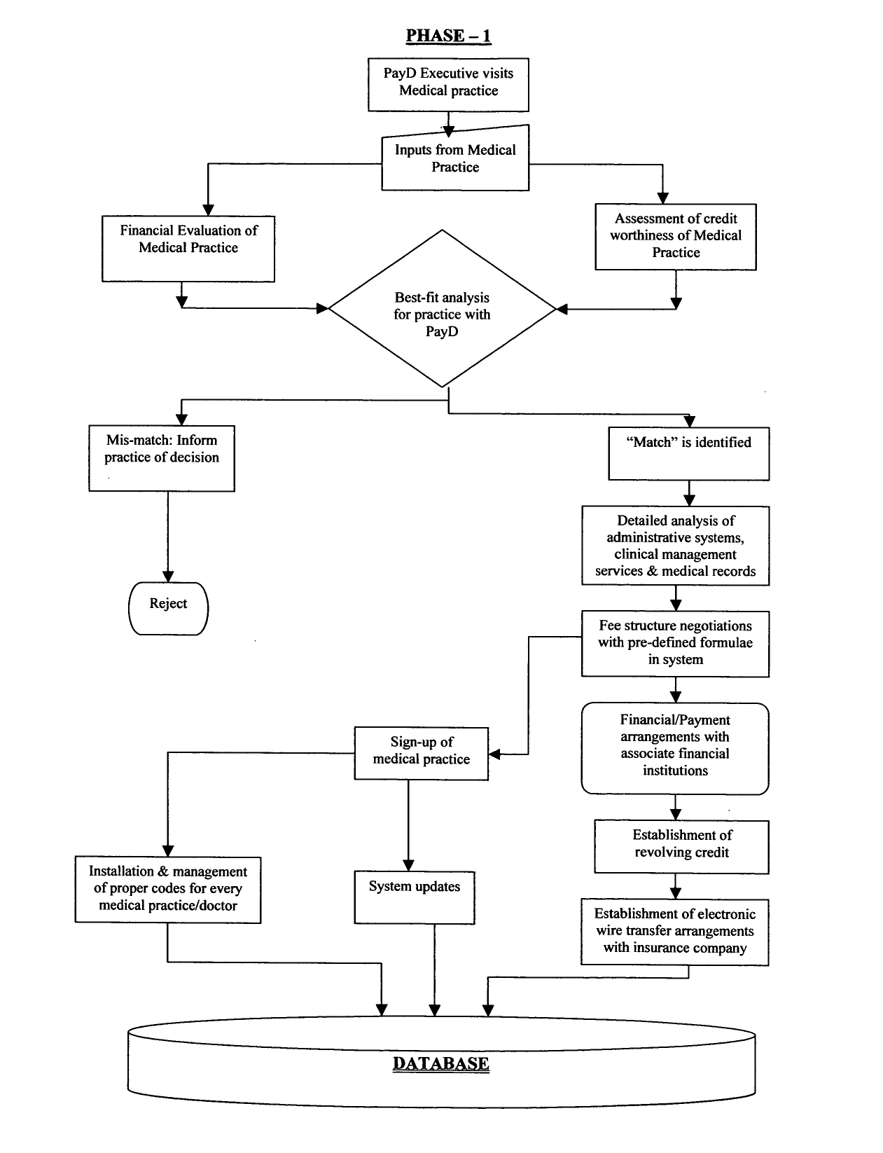

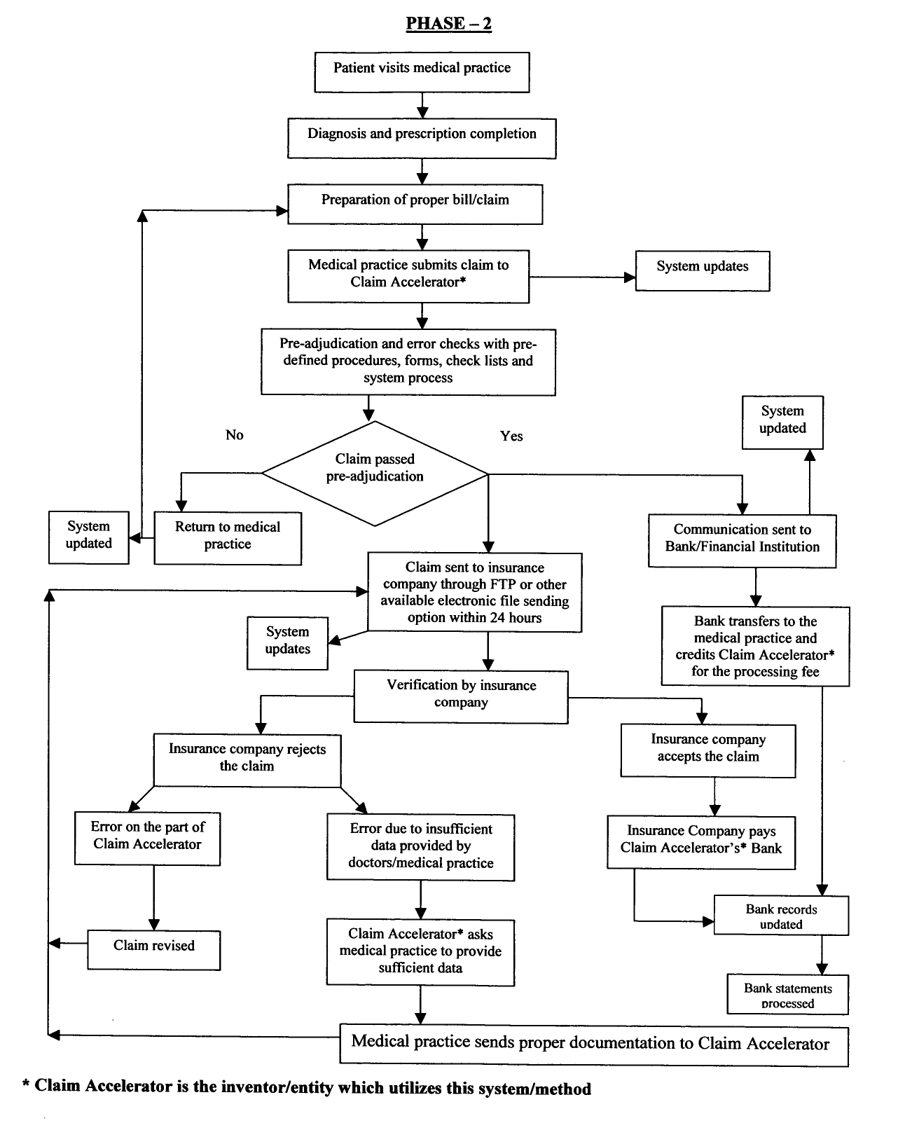

### FIELD OF THE INVENTION

The present invention relates to accelerating medical claim payments to medical practitioners and healthcare providers, ahead of the schedules of insurance payments, at economical charges, by use of systems, methods and processes.

### BACKGROUND OF THE INVENTION

Research and analysis performed by several interest groups have shown that healthcare costs are increasing every year. One of the reasons that the healthcare industry is becoming more complex, sophisticated and specialized. The procedures have become tedious and time-consuming. In addition to the increase in costs, there has been an increase in timeline between service delivery and payment. While medical science has improved the quality of life for the patients, not much has been done to improve the financial health of the medical practitioners. They continue to wait longer and longer to get their money from insurance companies. Currently, many doctors are burdened with pursuing claims and collections. They are spending more time on paper work and less time with patients.

There is a growing need for a system which pays the doctors much faster than the prevalent timeline.

There is a need to streamline the payment process to enable doctors to improve their cash flow. This will lead to better equipment and facilities with the doctors, leading to better care for patients.

There is a need for a system and process of pre-adjudication of medical claims by Claim Accelerators to enable faster payments.

There is a need for reducing the administrative costs, and, in turn, the savings would be spent on better treatment.

There is a need to have a system in place which compiles and sorts multiple insurance plans offered by multiple insurance companies having multiple contractual arrangements with multiple health care providers and multiple patients. Consequently, the system must arrive at each service-to-payment equation for each composite obligation.

There is a need for a system and method that accelerates the whole payment process without adding complexities of credit cards and other devices which add to the administrative steps for the patients and the doctors.

There is a need for a system, process and method which does not change any major functional arrangements of any of the parties involved, but accelerates the process in a non-invasive manner.

There have been attempts at streamlining the said payment process earlier, but they have not provided the optimum solution. The prior art tackles the issue in a very different manner. For example, U.S. Pat. No. 6,163,770 employs a digital electrical apparatus to generate output for insurance documentation for a first insurance policy having a first risk and claims while revealing a concurrent second insurance policy for a second risk, wherein the second risk is different from the first. The processor of this method is connected to a memory device for storing and retrieving operations including machine-readable signals in the memory device, to an input device for receiving input data and converting the input data into input electrical data, to a visual display unit for converting output electrical data into output having a visual presentation, to a printer for converting the output electrical data into printed documentation, wherein the processor is programmed to control the apparatus to receive the input data and to produce the output data by steps including: inputting actuarial assumptions defining the first insurance policy; and computing a value of a specific financial attribute of the first insurance policy; the method further including the step of inserting the value of the financial attribute in the first insurance policy and other printed documentation related to the first insurance policy.

U.S. Pat. No. 5,235,507 processes health insurance claims for self-insurers using a computer program. The program is used by a health insurance administrator or management company to automatically process health insurance claims even where the claims fall under different insurance policies. While the disclosed program facilitates the operations of the health insurance administrator or management company, it does nothing to improve the payment efficiencies at the point of service

U.S. Pat. No. 5,301,105 is described as a healthcare management system that integrates the patient, the healthcare provider, bank or other financial institution, insurance company, utilization reviewer, and employer to provide comprehensive pre-treatment, treatment, and post-treatment healthcare and the required financial support. The system purportedly allows for total health management which takes into account the patient's available cash balances, insurance coverage, and the like in administering the patient's wellness. A terminal at the physician's office accepts data entry through conventional credit cards as well as special “smart” cards. However, no technique for providing adjudicated third party payment at the point of service is described.

U.S. Pat. No. 5,065,315 employs a computer based system for collecting patient data and producing time oriented task lists within a given hospital facility. In U.S. Pat. No. 4,491,725 by Pritchard, medical insurance coverage verification is initiated from a patient identifying card so as to access a central database through a data processing network.

Still other data processing systems have utilized computer programs, computers and data processing communication networks to interconnect a plurality of care providers, banks and insurance companies through a central computer to allow determinations of coverage and payments for patients, such as in U.S. Pat. No. 4,858,121 by Barber et al, U.S. Pat. No. 4,916,611 by Doyle et al, and U.S. Pat. No. 5,070,452 by Doyle et al.

Such prior art shows that there is a growing need for a system of methods and processes that accelerates the payment to the doctors for their professional services, in a seemless, non-invasive manner which reduces cost, diminishes administrative follow-up, and accelerates claims processing without any additional device to be used by doctors and patients.

This new system addresses the above need. It creates a business method, using systems and processes, that enable a doctor to receive his payment within 48 hours in an error free, straight-line processing experience, in a controlled performing environment.

### SUMMARY OF THE INVENTION

The invention relates to a method, including systems and processes, to address the need for accelerated claim processing within 48 hours in an error-free straight-line process. It comprises the steps of having a meeting with the medical practice, verification of the financials, agreement on the cost-effective fee structure, arrangements on revolving credit, establishment of audit procedures and development of database with knowledge parameters. It also comprises the operating procedure of submission of claims, processing of claims, error identification, data sufficiency checks, acception/rejection criteria, and payment/collection procedures.

The initial set-up of a medical practice of a practitioner as an associate member will require a visit to his/her office to evaluate the financials and business credit worthiness. There will be an analysis of their administrative systems, clinical management, patient care services, medical records documentation, and incident management and incident reporting processes (if applicable). Subsequently or concurrently, a fee arrangement will be negotiated based on pre-defined formulae using the business situation and size of the practice. Subsequently or concurrently, pre-arranged alliance group financial institutions will establish revolving credit for the practice. After the medical practice has signed-up with the Claim Accelerator, the concerned insurance company will be contacted to establish electronic wire transfer arrangements. Audit procedures will be established to ensure proper codings are followed. Communication method will be established to keep the medical practitioner updated on the coding and other matters in a periodic manner. Systems will be put in place to gather pertinent data useful for continual support of the health care industry.

The preferred embodiment of this invention for accelerated claim processing would be where the doctor submits all the claim's accumulated at the end of the day to the Claim Accelerator (the person or entity who is the process owner for this invention). The Claim Accelerator will perform pre-adjudication as well as error checks in accordance with pre-defined procedures and forms, designed and maintained in electronic format. If errors are found, that will be returned to the doctor. Error-free pre-adjudicated claims will be sent electronically to the insurance company through FTP or other available electronic file sending options. This process will be completed within 24 hours in a controlled and performing environment. The insurance company will normally accept or reject the claim in the next 24 hours. If the claim is accepted, the amount due to the doctor will be paid immediately. If the claim is rejected by the insurance company, and the error is found to be on the part of the Claim Accelerator, then the amount due to the doctor will be paid immediately. However, if the claim is rejected due to insufficient data provided, then the Claim Accelerator will ask the doctor to submit the claim with proper data. The procedures will be different if there are paper claims. Subsequently, the Claim Accelerator will follow-up with patients and insurance companies, check EOB/Electronic Remittance Advice, send patient statements, post payments and collections.

### DETAILED DESCRIPTION OF THE INVENTION

The invention relates to accelerating medical claim payments to medical practitioners and health care providers ahead of the schedules of insurance payments at economical charges, by use of systems, methods and processes. In a preferred embodiment for the health care business, the system, method and processes will help in reducing the time-line for doctors to receive claim payments from weeks and months to just 48 hours in an error-free straight-line claim processing experience, within a controlled and performing environment.

Doctors will subscribe to use this method to get paid much earlier than any of the available means today. Upon the doctors/medical practitioner's request, a meeting will be arranged at the medical practice. In the meeting, or as a result of that meeting, audited financials will be reviewed and a business credit check will be performed. Major areas of healthcare operations will be analyzed, including: Administrative systems, clinical management, patient care services, medical records documentation, and incident management and incident reporting processes (if applicable).

The doctor will then agree on the charges and sign-off on the project. The Claim Accelerator will sent necessary paperwork to the financial institution in order to establish a revolving credit for 2-3 months of revenue. The Claim Accelerator will establish electronic wire transfer routine with the insurance company, if possible.

As additional steps in reaching a state of readiness-to-serve, the Claim Accelerator will establish routines to have periodic audits of medical practices and any off-site locations, and also establish a period communication method to keep doctors and other participants updated on code revisions, etc.

As part of Readiness-To-Serve, the Claim Accelerator will also set-up a server with software that enables medical billing and claim management with the programs required in this business method. The server will be accessible through FTP or other electronic access methods with security and encryption, to qualify as HIPAA complaint. He will also equip himself, through these systems, to develop knowledge as required by health care industry participants, and also commercial insurance carriers, medicare, medicaid and more. This will help with bulletins and training, etc.

More to ensure RTS, there will be defined and documented processes, procedures and check-lists to ensure that all deliverables of pre-adjudication are error-free and defect-free.

In a normal operational mode, the doctor will submit the claims electronically, at the end of the day (or week). The claims will go through the rigor of pre-adjudication using check-lists. If the claim is having any errors or defects, it will be returned to the doctor for rectification, in accordance with established procedures. If the claim is found to be good, then the next step in the process will be to send the claim electronically to the insurance company within 24 hours of receipt of claim from the doctor.

Next, the insurance company will accept or reject the claim. If the claim is rejected due to error on the part of the Claim Accelerator, the doctor will be paid regardless. If the claim is having some data issues and other defects, then the claim will be returned to the doctor for rectification. In the scenario of a good claim, the doctor will get his payment within 48 hours, using this method, systems and process.

There will be other normal operating mode processes, including follow-up with both patients and insurance companies after the claims have been sent, checking of EOB/Electronic remittance advice, sending of patient statements, posting of payments and collections.

I claim:

1. An electronic insurance claim acceleration system and business method which facilitates faster insurance payment to doctors, shortening the time-span of medical claim/receipt to 48 hours in an error-free straight-line claim experience within a controlled performing environment. The system and method comprises of:
a) Audit procedures for medical practice
b) Verification of the financials of a medical practice
c) Configured cost-effective fee structures.
d) Standard terms and conditions for claim acceleration.
e) Operating procedures for submission of claims, processing of claims, error-identification, and payment/collections.
f) Audit procedures for off-site locations
g) Databases implemented for optimal knowledge parameters.
h) Software for enabling billing and claim management.
i) Hardware and server of pre-defined configuration
j) Rules for use of FTP, data security, and encryption
k) Standard data sharing forms and patient statements in electronic format.
l) Check lists for data sufficiency
m) Check lists for acception/rejection criteria
n) Process for establishing electronic wire transfer arrangements with insurance companies.
o) Communication policy for coding and other data dissemination to doctors and other participants in the process.

2. The system and method of claim 1, further including an onsite analysis of the medical practice to review major areas of healthcare operations, including administrative systems, clinical management, patient care services, medical records documentation and incident reporting processes.

3. The system and method of claim 1, further including a mechanism of establishing a revolving credit limit equal to two times the monthly insurance payments with financial institutions.

4. The system and method of claim 1, further including submission of claims through electronic medium to the appropriate insurance company within a short time span of 24 hours.

5. A method to analyze risk factors in evaluating medical practice.

6. The method of claim 5, further including basic parameters that could be used in measuring efficiency of billing and coding systems in medical practice.

7. The method of claim 5, further including a method to maintain compliance and reduce the risk factors, by evaluating 30 medical charts per doctor, and creating formatted reports of findings.

8. The method of claim 5, further including a quarterly formatted analysis based on the prior findings with a sampling of 30 medical charts per physician.

9. The system and method in claim 1, further including a method that can be implemented for Real-time payment system, by use of which the risk can be managed and payments could be processed in real-time.

10. A method to record, monitor and report on data encompassing Healthcare Patient Quality and Cost Indicators such as drug usage, frequency of use, reactions, patient populations, trends, costs, etc.

11. The method in claim 10, further including a method to record, monitor and report on data encompassing Treatment Profiles showing the effective treatment for a disease based on the data.
